(19) United States
(12) Patent Application Publication
(10) Pub. No.: US 2009/0048823 A1
(43) Pub. Date: Feb. 19, 2009

(54) SYSTEM AND METHODS FOR OPINION MINING

(75) Inventors: Bing Liu, Winnetka, IL (US); Xiaowen Ding, Chicago, IL (US)

Correspondence Address: AKERMAN SENTERFITT, P.O. BOX 3188, WEST PALM BEACH, FL, 33402-3188, US

(73) Assignee: THE BOARD OF TRUSTEES OF THE UNIVERSITY OF ILLINOIS, URBANA, IL (US)

(21) Appl. No.: 12/177,562

(22) Filed: Jul. 22, 2008

Related U.S. Application Data
(60) Provisional application No. 60/956,260, filed on Aug. 16, 2007.

(51) Int. Cl. G06F 17/27

(52) U.S. Cl. 704/9

(57) ABSTRACT

A system that incorporates teachings of the present disclosure may include, for example, a system having a controller to identify from commentaries of an object or service one or more context-dependent opinions associated with one or more features of the object or the service, and synthesize a semantic orientation for each of one or more context-dependent opinions of the one or more features. Additional embodiments are disclosed.

### PRIOR APPLICATION

The present application claims the priority of U.S. Provisional Patent Application Ser. No. 60/956,260 filed Aug. 16, 2007. All sections of the aforementioned application are incorporated herein by reference.

### FIELD OF THE DISCLOSURE

The present disclosure relates generally to opinion mining techniques, and more specifically to a system and methods for opinion mining.

### BACKGROUND

With the rapid expansion of e-commerce over the past 10 years, more and more products are sold on the Internet, and more and more people are buying products online. In order to enhance customer shopping experience, it has become a common practice for online merchants to enable their customers to write reviews on products that they have purchased. With more and more users becoming comfortable with the Internet, an increasing number of people are writing reviews. As a result, the number of reviews that a product receives can grow rapidly. Some popular products can get hundreds of reviews or more at large merchant sites. Many reviews are also long, which makes it hard for a potential customer to read them to make a decision whether to purchase the product. If the consumer only reads a few reviews, the consumer may get only a biased view. The large number of reviews also makes it hard for product manufacturers to keep track of customer sentiments on their products.

In the past few years, many researchers have studied opinion mining [see references below: 1, 3, 11, 13, 26, 35]. The main tasks are to find product features that have been commented on by reviewers, and to decide whether the comments are positive or negative. Both tasks are very challenging. Although several methods on opinion mining exist, there is still not a general framework or model that clearly articulates various aspects of the problem and their relationships. In [11], a method is proposed to use opinion words to perform the second task. Opinion words are words that are commonly used to express positive or negative opinions (or sentiments), e.g., “amazing”, “great”, “poor” and “expensive”.

The method basically counts the number of positive and negative opinion words that are near the product feature in each review sentence. If there are more positive opinion words than negative opinion words, the final opinion on the feature is positive or otherwise negative. The set of opinion words is usually obtained through a bootstrapping process using the WordNet [6]. This method is simple and efficient, and gives reasonable results. A similar method is also proposed in a slightly different context in [15]. An improvement of the method is reported in [26]. However, these techniques have shortcomings.

For example, these methods do not have an effective mechanism to deal with context dependent opinion words. There are many such words. For example, the word “small” can indicate a positive or a negative opinion on a product feature depending on the product and the context. There is probably no way to know the semantic orientation of a context dependent opinion word by looking at only the word and the product feature that it modifies without prior knowledge of the product or the product feature. Asking the user to provide such knowledge is not scalable due to the huge number of products, product features and opinion words. In addition, when there are multiple conflicting opinion words in a sentence, existing methods are unable to deal with them well.

Opinion analysis has been studied by many researchers in recent years. Two main research directions are sentiment classification and feature-based opinion mining. Sentiment classification investigates ways to classify each review document as positive, negative, or neutral. Representative works on classification at the document level include [4, 5, 7, 10, 24, 25, 27, 30].

Sentence level subjectivity classification is studied in [8], which determines whether a sentence is a subjective sentence (but may not express a positive or negative opinion) or a factual one. Sentence level sentiment or opinion classification was studied in [8, 11, 15, 21, 26, 31, etc]. Other related works at both the document and sentence levels include those in [2, 7, 13, 14, 34].

Most sentence level and even document level classification methods are based on identification of opinion words or phrases. There are basically two types of approaches: corpus-based approaches, and dictionary-based approaches. Corpus-based approaches find co-occurrence patterns of words to determine the sentiments of words or phrases, e.g., the works in [8, 30, 32]. Dictionary-based approaches use synonyms and antonyms in WordNet to determine word sentiments based on a set of seed opinion words. Such approaches are studied in [1, 11, 15].

Reference [11] proposes the idea of opinion summarization. It has a method for determining whether the opinion expressed on a product is positive or negative based on opinion words. A similar method is also used in [15]. These methods are improved in [26] by a more sophisticated method based on relaxation labeling. In [35], a system is reported for analyzing movie reviews in the same framework. However, the system is domain specific. Methods related to sentiment analysis include [3, 13, 14, 16, 17, 18, 19, 20, 22, 28, 32]. Reference [12] studies the extraction of comparative sentences and relations.

### BRIEF DESCRIPTION OF THE DRAWINGS

FIG. 1 depicts an illustrative embodiment of a method utilized for opinion mining;

FIG. 2 depicts an illustrative embodiment of a communication system to which the method of FIG. 2 can be applied;

FIG. 3 depicts another illustrative embodiment of a method that can be applied to the communication system of FIG. 2;

FIG. 4 depicts a diagrammatic representation of a machine in the form of a computer system within which a set of instructions, when executed, may cause the machine to perform any one or more of the methodologies discussed herein;

Table 1 depicts an illustrative embodiment of characteristics of review data;

Table 2 depicts an illustrative embodiment of results of opinion sentence extraction and sentence orientation prediction; and

Table 3 depicts an illustrative embodiment of a comparison of FBS, OPINE and SAR based on a benchmark data set in reference [11] consisting of all reviews of the first five products in Table 2.

### DETAILED DESCRIPTION

One embodiment of the present disclosure entails a computer-readable storage medium having computer instructions for identifying one or more tangible or intangible features of an object from opinionated text generated by a plurality of users, each user expressing one or more opinions about the object, identifying in the opinionated text one or more context-dependent opinions associated with the one or more tangible or intangible features of the object, and determining a semantic orientation for each of the one or more context-dependent opinions of the one or more tangible or intangible features.

Another embodiment of the present disclosure entails a computer-readable storage medium having computer instructions for identifying one or more tangible or intangible features of one or more articles of trade from commentaries directed to the one or more articles of trade, identifying in the commentaries one or more context-dependent opinions associated with the one or more tangible or intangible features of the one or more articles of trade, and determining a semantic orientation for each of the one or more context-dependent opinions of the one or more tangible or intangible features.

Yet another embodiment of the present disclosure entails a computer-readable storage medium having computer instructions for identifying one or more intangible features of one or more services from commentaries directed to the one or more services, identifying in the commentaries one or more context-dependent opinions associated with the one or more intangible features of the one or more services, and determining a semantic orientation for each of the one or more context-dependent opinions of the one or more intangible features.

Another embodiment of the present disclosure entails a system having a controller to identify from commentaries of an object or service one or more context-dependent opinions associated with one or more features of the object or the service, and synthesize a semantic orientation for each of one or more context-dependent opinions of the one or more features.

Yet another embodiment of the present disclosure entails a method involving publishing opinion data synthesized by a system from commentaries directed to an object or service. The system can be adapted to synthesize the opinion data by identifying from the commentaries of the object or service one or more context-dependent opinions associated with one or more features of the object or the service, and determining a semantic orientation for each of one or more context-dependent opinions of the one or more features.

In general, opinions can be expressed on anything, e.g., goods or services, articles of trade, a product, an individual, an organization, an event, a topic, etc. We use the general term object to denote the entity that has been commented on. The object has a set of components (or parts) and also a set of attributes (or properties). Thus the object can be hierarchically decomposed according to the part-of relationship, i.e., each component may also have its sub-components and so on. For example, a product (e.g., a car, a digital camera) can have different components, an event can have sub-events, a topic can have sub-topics, etc. For illustrative purposes only, an object can be defined without limitation as follows:

Definition (object): An object O can be an entity such as a product, person, event, organization, or topic. It can be associated with a pair, O: (T, A), where T is a hierarchy or taxonomy of components (or parts), sub-components, and so on, and A is a set of attributes of O. Each component has its own set of sub-components and attributes. What follows are illustrative objects.

### EXAMPLE 1

A particular brand of digital camera can be an object. It has a set of components, e.g., lens, battery, etc., and also a set of attributes, e.g., picture quality, size, etc. The battery component also has its set of attributes, e.g., battery life, battery size, etc. Essentially, an object is represented as a tree. The root is the object itself. Each non-root node is a component or sub-component of the object. Each link is a part-of relationship. Each node is also associated with a set of attributes. An opinion can be expressed on any node and any attribute of the node.

### EXAMPLE 2

Following Example 1, one can express an opinion on the camera (the root node), e.g., “I do not like this camera”, or on one of its attributes, e.g., “the picture quality of this camera is poor”. Likewise, one can also express an opinion on any one of the camera's components or the attribute of the component.

For simplification purposes, the word “features” will be used from hereon to represent both components and attributes, which can omit the hierarchy discussed earlier. Using features to describe products, services, or other descriptive entities is also common in practice. In this framework the object itself can also be treated as a feature.

Let a review derived from commentaries or opinionated data be r. In the most general case, r consists of a sequence of sentences r= [symbol] s₁, s₂, . . . , sₘ [symbol] .

Definition (explicit and implicit feature): If a feature f appears in review r, it is called an explicit feature in r. If f does not appear in r but is implied, it is called an implicit feature in r.

### EXAMPLE 3

“battery life” in the following sentence is an explicit feature: “The battery life of this camera is too short”. “Size” is an implicit feature in the following sentence as it does not appear in the sentence but it is implied: “This camera is too large”. Here, “large” can be referred to as a feature indicator.

Definition (opinion passage on a feature): The opinion passage on feature f of an object evaluated in r is a group of consecutive sentences in r that expresses a positive or negative opinion on f.

It is possible that a sequence of sentences (at least one) in a review together expresses an opinion on an object or a feature of the object. Also, it is possible that a single sentence expresses opinions on more than one feature: “The picture quality is good, but the battery life is short”.

Most current research focuses on sentences, i.e., each passage consisting of a single sentence. In the present disclosure, sentences and passages will be used interchangeably as we work on sentences as well.

Definition (explicit and implicit opinion): An explicit opinion on feature f is a subjective sentence that directly expresses a positive or negative opinion. An implicit opinion on feature f is an objective sentence that implies an opinion.

### EXAMPLE 4

The following sentence expresses an explicit positive opinion: “The picture quality of this camera is amazing.” The following sentence expresses an implicit negative opinion: “The earphone broke in two days.” Although this sentence states an objective fact, it implicitly expresses a negative opinion on the earphone.

Definition (opinion holder): The holder of a particular opinion is the person or the organization that holds the opinion.

In the case of product reviews, forum postings and blogs, opinion holders are usually the authors of the postings. Opinion holders are more important in news articles because they often explicitly state the person or organization that holds a particular view. For example, the opinion holder in the sentence “John expressed his disagreement on the treaty” is “John”.

Definition (semantic orientation of an opinion): The semantic orientation of an opinion on a feature f states whether the opinion is positive, negative or neutral.

With these principles in mind, an object is represented with a finite set of features, F={f₁, f₂, . . . , fₙ}. Each feature fᵢ in F can be expressed with a finite set of words or phrases Wᵢ, which are synonyms. That is, we have a set of corresponding synonym sets W={W₁, W₂, . . . , Wₙ} for the n features. Since each feature fᵢ in F has a name (denoted by fᵢ), then fᵢ ε Wᵢ. Each author or opinion holder j comments on a subset of the features Sⱼ ⊂ F. For each feature fₖ ε Sⱼ that opinion holder j comments on, s/he chooses a word or phrase from Wₖ to describe the feature, and then expresses a positive, negative or neutral opinion on it.

This simple model covers most but not all cases. For example, it does not cover a situation described in the following sentence: “the view-finder and the lens of this camera are too close”, which expresses a negative opinion on the distance of the two components. The above cases are rare in product reviews.

This model introduces three main practical problems. Given a collection of reviews D as input, we have:

Problem 1: Both F and Ware unknown. In opinion analysis, we can perform three tasks:
Task 1: Identifying and extracting object features that have been commented on in each review d ε D.
Task 2: Determining whether the opinions on the features are positive, negative or neutral.
Task 3: Grouping synonyms of features, as different people may use different words to express the same feature.

Problem 2: F is known but W is unknown. This is similar to Problem 1, but slightly easier. All the three tasks for Problem 1 still need to be performed, but Task 3 becomes the problem of matching discovered features with the set of given features F.

Problem 3: W is known (then F is also known). We only need to perform Task 2 above, namely, determining whether the opinions on the known features are positive, negative or neutral after all the sentences that contain them are extracted (which is simple).

Clearly, the first problem is the most difficult to solve. Problem 2 is slightly easier. Problem 3 is the easiest.

### EXAMPLE 5

A cellular phone company wants to analyze customer reviews on a few models of its phones. It is quite realistic to produce the feature set F that the company is interested in and also the set of synonyms of each feature Wᵢ (although the set might not be complete). Accordingly, there is no need to perform Tasks 1 and 3.

Output: The final output for each evaluative text d is a set of pairs. Each pair is denoted by (f, SO), where f is a feature and SO is the semantic or opinion orientation (positive or negative) expressed in d on feature f. We can ignore neutral opinions in the output as they are not usually useful.

Note this model does not consider the strength of each opinion, i.e., whether the opinion is strongly negative (or positive) or weakly negative (or positive), but it can be added easily [31].

There are many ways to present the results. A simple way is to produce a feature-based summary of opinions on the object. That is, for each feature, we can show how many reviewers expressed negative opinions and how many reviewers expressed positive opinions. With such a summary, a potential customer can easily see how the existing customers feel about the object.

The discussions that follow focus on solving Problem 3. That is, we assume that all features are given, which is realistic for specific domains as Example 5 shows. The task will be to determine whether the opinion expressed by each reviewer on each product feature is positive, negative or neutral.

Generally speaking, opinion words around each product feature in a review sentence can be used to determine the opinion orientation on the product feature. As discussed earlier, the key difficulties are: (1) how to combine multiple opinion words (which may be conflicting) to arrive at the final decision, (2) how to deal with context or domain dependent opinion words without any prior knowledge from the user, and (3) how to deal with language constructs which can change the semantic orientations of opinion words. The present disclosure outlines several methods which make use of the review and sentence context, and general natural language rules to deal with these problems.

Opinion Words, Phrases and Idioms

Opinion (or sentiment) words and phrases are words and phrases that express positive or negative sentiments. Words that encode a desirable state (e.g., great, awesome) have a positive orientation, while words that represent an undesirable state have a negative orientation (e.g., disappointing). While orientations apply to most adjectives, there are those adjectives that have no orientations (e.g., external, digital). There are also many words whose semantic orientations depend on contexts in which they appear. For example, the word “long” in the following two sentences has completely different orientations, one positive and one negative:
“The battery of this camera lasts very long”
“This program takes a long time to run”

Although words that express positive or negative orientations are usually adjectives and adverbs, verbs and nouns can be used to express opinions as well, e.g., verbs such as “like” and “hate”, and nouns such as “junk” and “rubbish”.

Researchers have compiled sets of such words and phrases for adjectives, adverbs, verbs, and nouns respectively. Each set is usually obtained through a bootstrapping process [11] using the WordNet. The present disclosure utilizes the lists from the authors of [11]. However, their lists only have opinion words that are adjectives and adverbs. The present disclosure further makes use of verb and noun lists identified in the same way. The present disclosure also makes use of lists of context dependent opinion words.

In order to make use of the different lists, part-of-speech (POS) tagging can be used. Many words can have multiple POS tags depending on their usages. The part-of-speech of a word is a linguistic category that is defined by its syntactic or morphological behavior. Common POS categories in English are: noun, verb, adjective, adverb, pronoun, preposition, conjunction and interjection. The present disclosure makes use of for example the NLProcessor linguistic parser [23] for POS tagging.

Idioms: Apart from opinion words, there are also idioms. Positive, negative and dependent idioms can also be identified. In fact, most idioms express strong opinions, e.g., “cost (somebody) an arm and a leg”. The present disclosure made use and annotated more than 1000 idioms. Although this task can be time consuming, it is only a one-time effort.

Aggregating Opinions for a Feature

The lists of positive, negative and dependent words, and idioms can be used to identify (positive, negative or neutral) opinion orientation expressed on each product feature in a review sentence as follows.

Given a sentence s that contains a set of features, opinion words in the sentence are identified first. Note that a sentence may express opinions on multiple features. For each feature f in the sentence, an orientation score can be computed for the feature. A positive word can be assigned the semantic orientation score of +1, and a negative word can be assigned the semantic orientation score of −1. All the scores can be summed up using the following score function:

$$score ( f ) = {\sum }_{{w}_{i} : {w}_{i} ∈ s ⋀ {w}_{i} ∈ V} \frac{{w}_{i} . SO}{d ( {w}_{i} , f )} , \qquad ( 1 )$$

where wᵢ is an opinion word, V is the set of all opinion words (including idioms) and s is the sentence that contains the feature f and d(wᵢ, f) is the distance between feature f and opinion word wᵢ in the sentence s. wᵢ.SO is the semantic orientation of the word w_{i.} The multiplicative inverse in the formula is used to give low weights to opinion words that are far away from the feature f.

The aforementioned function performs better than the simple summation of opinions in [11, 15] because far away opinion words may not modify the current feature. However, setting a distance range/limit within which the opinion words are considered does not necessarily perform well either because in some cases, the opinion words may be far away. The proposed new function deals with both problems nicely.

Note that the feature itself can be an opinion word as it may be an adjective representing a feature indicator, e.g., “reliable” in the sentence “This camera is very reliable”. In this case, score(f) is +1 or −1 depending on whether f (e.g., “reliable”) is positive or negative (in this case, Equation (1) will not be used).

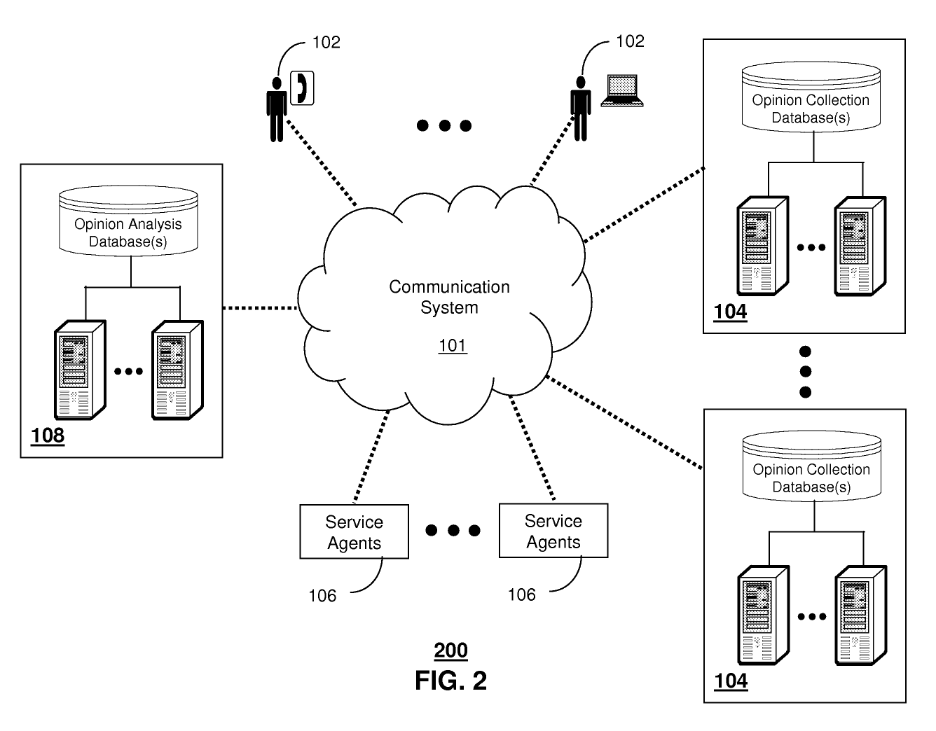

If the final score is positive, then the opinion on the feature in the sentence s is positive. If the final score is negative, then the opinion on the feature is negative. It is neutral otherwise. The algorithm is given in FIG. 2, where the variable orientation in the algorithm OpinionOrietation holds the total score. Several constructs need special handling, for which a set of linguistic rules is used:

Negation Rules: Negations include traditional words such as “no”, “not”, and “never”, and also pattern-based negations such as “stop”+“vb-ing”, “quit”+“vb-ing” and “cease”+“to vb”. Here, vb is the POS tag for verb and “vb-ing” is vb in its -ing form. The following rules are applied for negations:
Negation Negative→Positive //e.g., “no problem”
Negation Positive→Negative //e.g., “not good”
Negation Neutral→Negative //e.g., “does not work”, where “work” is a neutral verb.

As system can be used to detect pattern-based negations, and thereby apply the rules above. For example, the sentence, “the camera stopped working after 3 days”, conforms to the pattern “stop”+“vb-ing”, and is assigned the negative orientation by applying the last rule as “working” is neutral.

Note that “Negative” and “Positive” above represent negative and positive opinion words respectively.

“But” Clause Rules: A sentence containing “but” also needs special treatment. Phrases such as “With the exception of”, “except that”, and “except for” behaves similarly to “but” and are handled in the same way as “but”. The following illustrative algorithm:
If the product featured fᵢ appears in the “but” clause then for each unmarked opinion word ow in the “but” clause of the sentence sᵢ do

```
// ow can be a TOO word (see below) or Negation word
orientation += wordOrientation(ow, fⱼ, sᵢ);
  endfor
  If orientation ≠ 0 then
    return orientation
  else orientation = orientation of the clause before “but”
    If orientation ≠ 0 then
      return −1 * orientation
        else  return 0
endif
```

The algorithm above basically says that the semantic orientation of the “but” clause is followed first. If an orientation cannot be determined, the clause before “but” be looked at and its orientation negated.

TOO Rules: Sentences with “too”, “excessively”, and “overly” are also handled specially. We denote those words with TOO.
TOO Positive→Negative //e.g., “too good to be true”
TOO Negative→Negative //e.g., “too expensive”
TOO Dependent→Negative //e.g., “too small”

Handling Context Dependent Opinions

Contextual information in other reviews of the same product, sentences in the same review and even clauses of the same sentence can be used to infer the orientation of an opinion word in question.

Intra-sentence conjunction rule: For example, consider the sentence, “the battery life is very long”. It is not clear whether “long” means a positive or a negative opinion on the product feature “battery life”. A determination can be made whether any other reviewer said that “long” is positive (or negative). For example, another reviewer wrote “This camera takes great pictures and has a long battery life”. From this sentence, it can be discovered that “long” is positive for “battery life” because it is conjoined with the positive opinion word “great”. This technique can be referred to as an intra-sentence conjunction rule, which sets out a principle in which a sentence only expresses one opinion orientation unless there is a “but” word (or other similar word) which changes the direction of the sentence. The following sentence is unlikely to be used in common parlance: “This camera takes great pictures and has a short battery life.” It is much more natural to say: “This camera takes great pictures, but has a short battery life.”

Pseudo intra-sentence conjunction rule: Sometimes, one may not use an explicit conjunction “and”. Using the example sentence, “the battery life is long”, it is not clear whether “long” is positive or negative for “battery life”. A similar strategy can be applied. For instance, another reviewer might have written the following: “The camera has a long battery life, which is great”. The sentence indicates that the semantic orientation of “long” for “battery life” is positive due to “great”, although no explicit “and” is used.

Using these two rules, two cases are considered.

Adjectives as feature indicators: In this case, an adjective is a feature indicator. For example, “small” is a feature indicator that indicates feature “size” in the sentence, “this camera is very small”. It is not clear from this sentence whether “small” means positive or negative. The above two rules can be applied to determine the semantic orientation of “small” for “camera”.

Explicit features that are not adjectives: In this case, the proximity of opinion words to the feature words is used to determine the opinion orientations on the feature words. For example, in the sentence “the battery life of this camera is long”, “battery life” is the given feature and “long” is a nearby opinion word. Again the above two rules can be used to find the semantic orientation of “long” for “battery life”.

Inter-sentence conjunction rule: If the above two rules cannot be used to decide an opinion orientation, the context of a previous or next sentence (or clauses) can be used to decide the opinion orientation. That is, the intra-sentence conjunction rule can be extended to neighboring sentences. People can be expected to express the same opinion (positive or negative) across sentences unless there is an indication of an opinion change using words such as “but” and “however”. For example, the following sentences are natural: “The picture quality is amazing. The battery life is long”. However, the following sentences are not natural: “The picture quality is amazing. The battery life is short”. It is much more natural to say: “The picture quality is amazing. However, the battery life is short”.

Below, is an illustrative algorithm for determining an opinion orientation by context. The variable orientation is the opinion score on the current feature. Note that the algorithm only uses neighboring sentences. Neighboring clauses in the same sentence can be used in a similar way too.

```
if the previous sentence exists and has an opinion then
  if there is not a “However” or “But” word to change the
      direction of the current sentence, then
    orientation = the orientation of the last clause
    of the previous sentence
  else orientation = opposite orientation of the
  last clause of the previous sentence
elseif the next sentence exists and has an opinion then
    if there is a not “However” or “But” word to
    change the direction of the next
        sentence, then
      orientation = the orientation of the first clause of the next sentence
    else orientation = opposite orientation of the last
    clause of the next sentence
else orientation = 0
endif
```

It is possible that in the reviews of a product the same adjective for the same feature has conflicting orientations. For example, another reviewer may say that “small” is negative for camera size: “This camera is very small, which I don't like”. In this case, the above algorithm takes the majority view. That is, if more people indicate that “small” is positive for size, we will treat it as positive and vice versa. Note that if the above reviewer instead says: “This camera is too small”. The word “small” is not given an orientation because “too” here indicates an negative opinion in any case (see the above TOO rules).

Synonym and Antonym Rule: If a word is found to be positive (or negative) in a context for a feature, its synonyms are also considered positive (or negative), and its antonyms are considered negative (or positive). For example, in the above sentence, “long” is positive for battery life. Accordingly, it can be determined that “short” is negative for battery life.

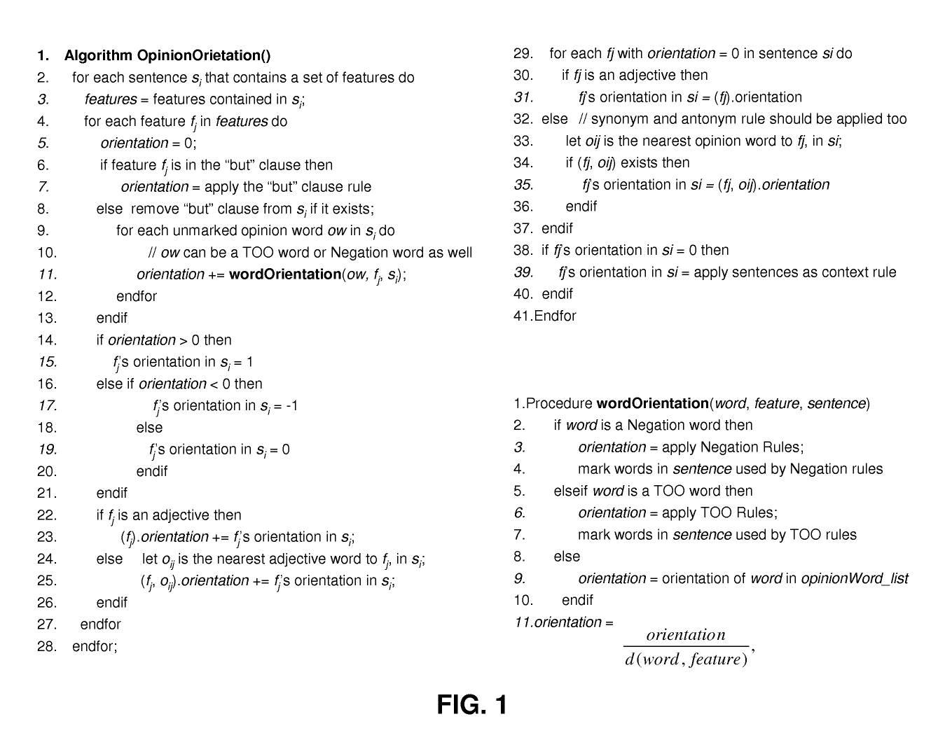

The collective algorithms discussed above are illustrated in FIG. 1. Lines 22-26 and lines 29-41 need some additional explanation. Lines 29-41 deal with product features in which the first iteration (lines 2-28) did not identify opinion orientations for the product features because there were no opinion words or the opinion words have context dependent orientations. Thus, lines 29-41 use the three strategies above to handle the context dependent (or undecided) cases. Line 30 states that if the feature fⱼ is an adjective (i.e., a feature indicator), then its orientation simply takes the majority orientation in other reviews (line 31). If the feature fⱼ is not a feature indicator, the algorithm finds the nearest opinion word oᵢⱼ and uses the dominant orientation in other reviews on the pair (fⱼ, oᵢⱼ) (line 35), which is stored in (fⱼ, oᵢⱼ).orientation and is computed in line 25 (see below). If (fⱼ, oᵢⱼ) does not exist, the algorithm determines if oᵢⱼ's synonym or antonym exists in the (f, o) pair list. If it exists, the algorithm applies the synonym and antonym rule. If the algorithm still cannot find a match in the (f, o) list, the orientation of feature fⱼ remains neutral. Note that the application of the synonym and antonym rule is not included in the algorithm in FIG. 1 for simplicity of illustration, but can be added easily.

Lines 22-26 record opinions identified in other sentences or reviews, which are used in lines 29-41. Line 22 states that if feature fⱼ is an adjective (i.e., a feature indicator), the algorithm aggregates its orientations in different reviews (line 23). If the feature fⱼ is not a feature indicator (line 24), the algorithm finds the nearest opinion word oᵢⱼ (line 24) and again sums up its orientation in different reviews (line 25). The orientation is stored in (fⱼ, oᵢⱼ).orientation. A pair is used to ensure that the opinion word oᵢⱼ is for the specific featured since an opinion word can modify multiple features with different orientations.

Empirical Evaluation

A system, called SAR (Semantic Analysis of Reviews), based on the proposed technique has been implemented in C++. This section evaluates SAR to assess its accuracy for predicting the semantic orientations of opinions on product features.

Experiments were carried out using customer reviews of 8 products: two digital cameras, one DVD player, one MP3 player, two cellular phones, one router and one antivirus software. The characteristics of each review data set are given in Table 1. The reviews of the first five products are the benchmark data set from [11] (http://www.cs.uic.edu/˜liub/FBS/FBS.html). The reviews of the last three products are annotated by us following the same scheme as that in [11]. All our reviews are from amazon.com.

An issue in judging opinions in reviews is that the decisions can be subjective. It is usually easy to judge whether an opinion is positive or negative if a sentence clearly expresses an opinion. However, deciding whether a sentence offers an opinion for some fuzzy cases can be difficult. For the difficult sentences, a consensus was reached between the primary human reviewers.

Note that the features here are considerably more than those used in [11] because [11] only considers explicit noun features. Here, the experiments made included both explicit and implicit features of all POS tags. There are a large number of features that are verbs and adjectives, which often indicate implicit features. Duplicate features that appear in different sentences or reviews are also counted to reflect opinions from different reviewers on the same feature. Note also that there are many features that are synonyms.

The NLProcessor system [23] was used to generate POS tags. After POS tagging, the SAR system was applied to find orientations of opinions expressed on product features.

Table 2 gives the experimental results. The performances were measured using the standard evaluation measures of precision (p), recall (r) and F-score (F), F=2pr/(p+r).

In this table, three techniques were compared: (1) the proposed new technique SAR, (2) the proposed technique without handling context dependency of opinion words, (3) the existing technique FBS in [11]. Table 3 also compares the proposed technique with the Opine system in [26], which improved FBS.

From Table 2, it can be observed that the new algorithm SAR has a much higher F-score than the existing FBS method. The main loss of FBS is in the recall. The precision is slightly higher because it is only able to find obvious cases. The new SAR method is able to improve the recall dramatically with almost no loss in precision. Note that FBS [11] only deals with explicit noun features. It was also extended to consider all types of features. The results of FBS reported are from the improved system of its authors. It still uses the same technique as that in [11].

It can also be observed from Table 2 that handling context dependent opinion words helps significantly too. Without it (SAR—without context dependency handling), the average F-score dropped to 87% (Column 7) due to poor recall (Column 6) because many features are assigned the neutral orientation.

Similarly, it can be observed that the score function of Equation (1) is highly influential as well. Using the simple summation of semantic orientations without considering the distance between opinion words and product features as in FBS produces a worse average F-score (0.87 in Column 10) (SAR—Without using Equation (1)). Thus, it can be concluded that both the score function and the handling of context dependent opinion words are very useful as proposed by the present disclosure.

Table 3 compares the results of the Opine system reported in [26] based on the same benchmark data set (reviews of the first 5 products in Table 1). It was shown in [26] that Opine outperforms FBS. Here, only average results could be compared as individual results for each product were not reported in [26]. It can be observed that SAR outperforms Opine on both precision and recall. Furthermore, the SAR is much simpler than the relaxation labeling method used in [26]. In the table, we also include the results of the FBS method on the reviews of the first 5 products. Again, SAR is dramatically better in recall and F-score with almost no loss in precision.

From the above illustrations it follows that the present disclosure is highly effective and is markedly better than existing methods.

FIG. 2 depicts an illustrative embodiment of a communication system 200 applying the above principles and other embodiments. The communication system 200 can comprise a communication network 101 such as for example the Internet, a common circuit-switched or packet-switched voice network, and/or other suitable communication networks for connecting individuals to computing devices or other parties. The communication system 200 can be coupled to an opinion analysis system (OAS) 108 which can encompass the embodiments of SAR as illustrated above as well as other embodiments that will be discussed shortly. The communication system 200 can be coupled also to customers 102 by way of a voice connection or computing connection, providing said customers access to service agents 106. Service agents 106 can represent humans who can interact with the customers 102 over a voice communication session which can be recorded. Service agents 106 can also represent a computing device such as a common interactive voice response (IVR) system which can navigate a caller through options and can record voice conversations as well. The human agent and the IVR can also operate cooperatively.

Customers 102 can also interact directly with opinion collection computing devices (OCCD) 104 using a browser on a computing device such as a computer, cell phone, or other Internet-capable communication device. The OCCD 104 can represent an Internet website of a service provider who can collect commentaries on any object such as for example a celebrity, a politician, product, service, or any other tangible or intangible object in which customers 102 can form an opinion, suggestion, or otherwise. The OCCDs 104 can also collect recorded conversations with the service agents 106. Generally speaking, the OCCDs 104 can collect any responses initiated by customers 106 in its raw form which can be subsequently processed by the OAS 108

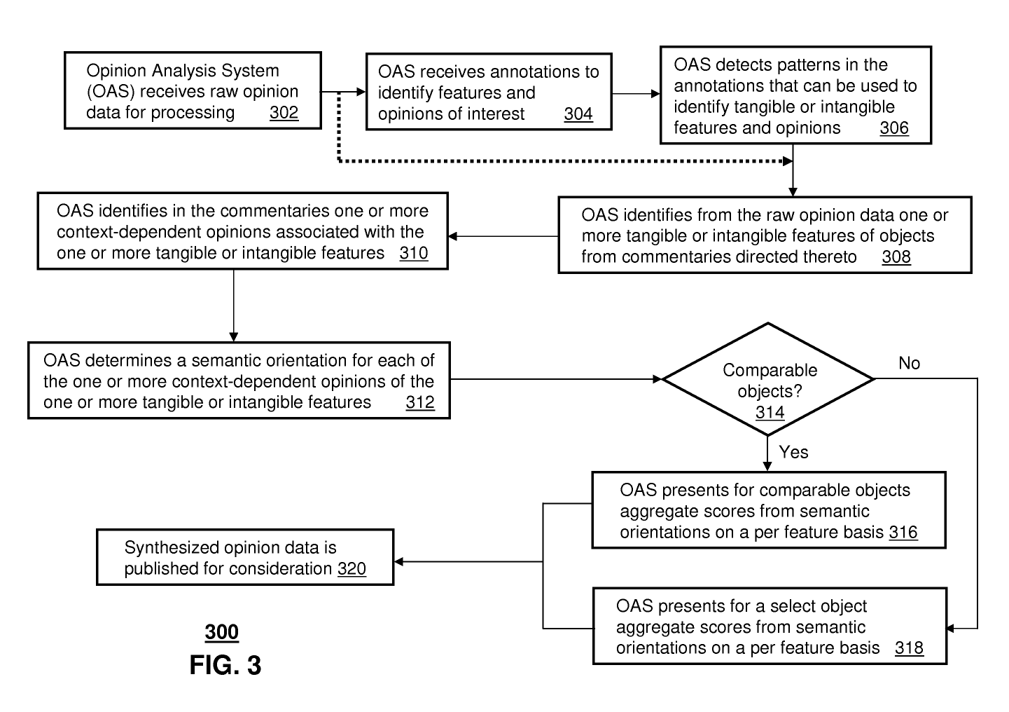

FIG. 3 depicts an illustrative embodiment of a method 300 operating in portions of communication system 200. Method 300 can begin with the OAS 108 receiving raw customer response data (which will be referred to herein for convenience as opinion data) from a source such as the OCCDs 104. To assist the OAS 108 in synthesizing the raw opinion data, the OAS can receive in step 304 annotations from a service provider or other party to identify features and/or opinions of interest. For example, a service provider of goods or services may have an interest in certain features or opinions of a product or service that it wants the OAS 108 to synthesize opinions from. For example, a service provider of cell phones may have a particular interest in the attribute of battery life, form factor desirability, usability, and so on. Components or attributes of this type can be annotated for the OAS 108. From the annotations provided, the OAS 108 can be programmed in step 306 to detect patterns therefrom, thereby assisting the OAS 108 in steps 308-310 to identify one or more tangible or intangible features and context-dependent opinions from the raw opinionated data provided in step 302, and synthesize therefrom in step 312 a semantic orientation for each of the context-dependent opinions utilizing the techniques discussed earlier.

The OAS 108 can be further programmed to detect in step 314 comparable objects (e.g., cell phones from Nokia, Motorola, Samsung and LG, or printers from HP, Epson, Brothers, and so on). If comparable objects are detected, the OAS 108 can proceed to step 316 where it can present the comparable objects each listing aggregate scores from semantic orientations for comparable features on a per feature basis. If comparable objects are not found, the OAS 108 can proceed to step 318 where it presents aggregate scores for the object in question on a per feature basis. In step 320, the service provider (or other reporting organization such as “Consumer Reports”) can publish in whole or in part the synthesized opinion results created by the OAS 108 in steps 316-318. The publication can be a hard copy of marketing collateral, published results on a website, or some other suitable forms of distribution.

From the aforementioned embodiment, it would be evident to an artisan of ordinary skill in the art that the present disclosure proposes a highly effective method for identifying semantic orientations of opinions expressed by reviewers on product features. It is able to deal with two major problems existing systems and methods are unable to readily address, (1) opinion words whose semantic orientations are context dependent, and (2) aggregating multiple opinion words in the same sentence. For (1), the present disclosure proposed a holistic approach that can accurately infer the semantic orientation of an opinion word based on the review context. For (2), the present disclosure proposed a new function to combine multiple opinion words in the same sentence. Prior systems and methods only consider explicit opinions expressed by adjectives and adverbs. The present disclosure considers both explicit and implicit opinions. The present disclosure also addresses implicit features represented by feature indicators, thus making the proposed method more complete. Experimental results show that the proposed technique performs markedly better than the state-of-the-art existing methods for opinion mining.

From the foregoing descriptions, it would be evident to an artisan with ordinary skill in the art that the aforementioned embodiments can be modified, reduced, or enhanced without departing from the scope and spirit of the claims described below. For example, method 300 can be adapted so that annotations are not provided, in which case the OAS 108 determines features and context-dependent opinions without extrinsic assistance. In general terms, the present disclosure can be applied to any form of biased responses. That is, the present disclosure can be applied to data having biased responses to identify tangible or intangible features therefrom, context-dependent opinions, and to synthesize semantic orientations for each opinion. From the semantic orientations, an aggregate score can be determined for each feature, which can be utilized by any individual to identify collective sentiments o.

Other suitable modifications can be applied to the present disclosure. Accordingly, the reader is directed to the claims for a fuller understanding of the breadth and scope of the present disclosure.

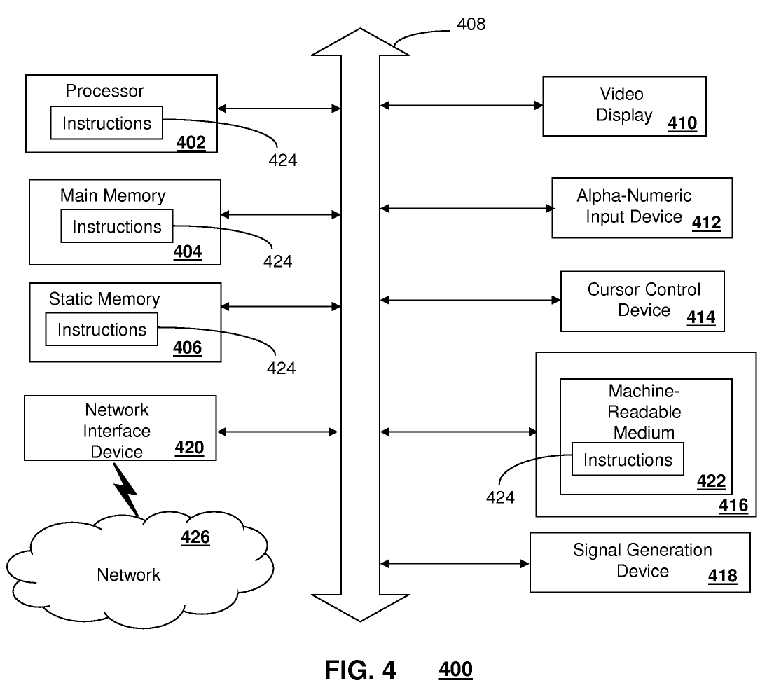

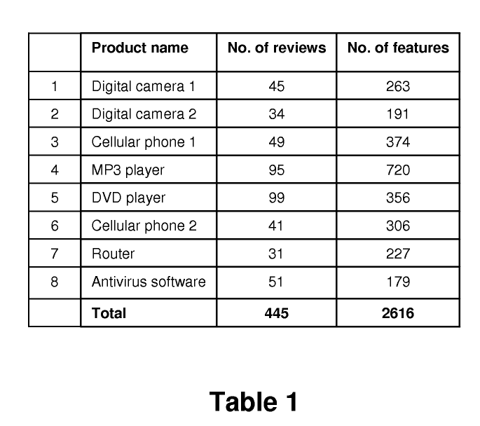

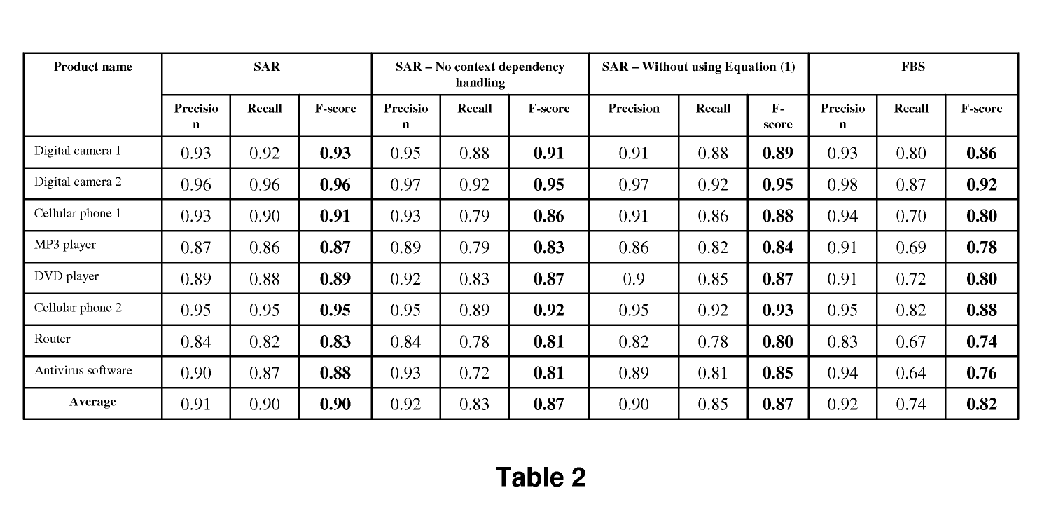

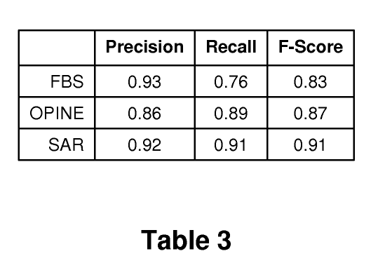

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

### REFERENCES

[1]. A. Andreevskaia and S. Bergler. Mining WordNet for Fuzzy Sentiment: Sentiment Tag Extraction from WordNet Glosses. In EACL'06, pp. 209-216, 2006.
[2]. P. Beineke, T. Hastie, C. Manning, and S. Vaithyanathan. An Exploration of Sentiment Summarization. In Proc. of the AAAI Spring Symposium on Exploring Attitude and Affect in Text: Theories and Applications, 2003.
[3]. G. Carenini, R. Ng, and A. Pauls. Interactive Multimedia Summaries of Evaluative Text. IUI'06, 2006.
[4]. S. Das, and M. Chen. Yahoo! for Amazon: Extracting market sentiment from stock message boards. APFA'01], 2001.
[5]. K. Dave, S. Lawrence, and D. Pennock. Mining the Peanut Gallery: Opinion Extraction and Semantic Classification of Product Reviews. WWW'03, 2003.
[6]. C. Fellbaum. WordNet: an Electronic Lexical Database, MIT Press, 1998.
[7]. M. Gamon, A. Aue, S. Corston-Oliver, and E. K. Ringger. Pulse: Mining customer opinions from free text. IDA'2005.
[8]. V. Hatzivassiloglou and J. Wiebe. Effects of adjective orientation and gradability on sentence subjectivity. COLING'00, 2000.
[9]. V. Hatzivassiloglou and K. McKeown. Predicting the Semantic Orientation of Adjectives. ACL-EACL'97, 1997.
[10]. M. Hearst. Direction-based Text Interpretation as an Information Access Refinement. In P. Jacobs, editor, Text-Based Intelligent Systems. Lawrence Erlbaum Associates, 1992.
[11]. M. Hu and B. Liu. Mining and summarizing customer reviews. KDD'04, 2004.
[12]. N. Jindal, and B. Liu. Mining Comparative Sentences and Relations. In AAAI'06, 2006.
[13]. N. Kaji and M. Kitsuregawa. Automatic Construction of Polarity-Tagged Corpus from HTML Documents. COLING/ACL'06, 2006.
[14]. H. Kanayama and T. Nasukawa. Fully Automatic Lexicon Expansion for Domain-Oriented Sentiment Analysis. EMNLP'06, 2006.
[15]. S. Kim and E. Hovy. Determining the Sentiment of Opinions. COLING'04, 2004.
[16]. S. Kim and E. Hovy. Automatic Identification of Pro and Con Reasons in Online Reviews. COLING/ACL 2006.
[17]. N. Kobayashi, R. Iida, K. Inui and Y. Matsumoto. Opinion Mining on the Web by Extracting Subject-Attribute-Value Relations. In Proc. of AAAI-CAAW'06, 2006.
[18]. L.-W. Ku, Y.-T. Liang and H.-H. Chen. Opinion Extraction, Summarization and Tracking in News and Blog Corpora. In Proc. of the AAAI-CAAW'06, 2006.
[19]. B. Liu, M. Hu, M. and J. Cheng. Opinion Observer: Analyzing and comparing opinions on the Web. WWW-05, 2005.
[20]. S. Morinaga, K. Yamanishi, K. Tateishi, and T. Fukushima, Mining Product Reputations on the Web. KDD'02, 2002.
[21]. T. Nasukawa and J. Yi. Sentiment analysis: Capturing favorability using natural language processing. K-CA-2003.
[22]. V. Ng, S. Dasgupta and S. M. Niaz Arifin. Examining the Role of Linguistic Knowledge Sources in the Automatic Identification and Classification of Reviews. ACL'06, 2006.
[23]. NLProcessor—Text Analysis Toolkit. 2000. http://www.infogistics.com/textanalysis.html
[24]. B. Pang and L. Lee, Seeing Stars: Exploiting Class Relationships for Sentiment Categorization with Respect to Rating Scales. ACL'05, 2005.
[25]. B. Pang, L. Lee, and S. Vaithyanathan. Thumbs up? Sentiment Classification Using Machine Learning Techniques. EMNLP'2002, 2002.
[26]. A-M. Popescu and 0. Etzioni. Extracting Product Features and Opinions from Reviews. EMNLP-05, 2005.
[27]. E. Riloff and J. Wiebe. 2003. Learning extraction patterns for subjective expressions. EMNLP'2003, 2003.
[28]. V. Stoyanov and C. Cardie. Toward opinion summarization: Linking the sources. In Proc. of the Workshop on Sentiment and Subjectivity in Text, 2006.
[29]. R. Tong. An Operational System for Detecting and Tracking Opinions in on-line discussion. SIGIR 2001 Workshop on Operational Text Classification, 2001.
[30]. P. Turney. Thumbs Up or Thumbs Down? Semantic Orientation Applied to Unsupervised Classification of Reviews. ACL'02, 2002.
[31]. T. Wilson, J. Wiebe, and R. Hwa. Just how mad are you? Finding strong and weak opinion clauses. AAAI'04, 2004.
[32]. J. Wiebe, and R. Mihalcea. Word Sense and Subjectivity. In ACL'06, 2006.
[33]. J. Wiebe, and E. Riloff: Creating Subjective and Objective sentence classifiers from unannotated texts. CICLing, 2005.
[34]. H. Yu, V. Hatzivassiloglou. Towards answering opinion questions: Separating facts from opinions and identifying the polarity of opinion sentences. EMNLP'2003.
[35]. L. Zhuang, F. Jing, X.-Yan Zhu, and L. Zhang. Movie Review Mining and Summarization. CIKM-06, 2006.

What is claimed is:

1. A computer-readable storage medium, comprising computer instructions for:
identifying one or more tangible or intangible features of an object from opinionated text generated by a plurality of users, each user expressing one or more opinions about the object;
identifying in the opinionated text one or more context-dependent opinions associated with the one or more tangible or intangible features of the object; and
determining a semantic orientation for each of the one or more context-dependent opinions of the one or more tangible or intangible features.

2. The storage medium of claim 1, comprising computer instructions for identifying in the opinionated text the one or more tangible or intangible features of the object according to patterns of nouns found in the opinionated text.

3. The storage medium of claim 1, wherein each of the one or more context-dependent opinions comprises at least one of an explicit opinion and an implicit opinion, and wherein the storage medium comprises computer instructions for determining the semantic orientation of an implicit opinion from a related explicit opinion.

4. The storage medium of claim 3, wherein an implicit opinion is related to an explicit opinion contextually.

5. The storage medium of claim 1, comprising computer instructions for determining the semantic orientation for each of the one or more context-dependent opinions from related reviews or a known semantic orientation of another opinion found in proximity to the context-dependent opinion in question.

6. The storage medium of claim 5, wherein the other opinion comprises text having a negation construct, or an exception construct.

7. The storage medium of claim 1, wherein the semantic orientation comprises one of a positive opinion, a negative opinion, and a neutral opinion.

8. The storage medium of claim 1, comprising computer instructions for determining an aggregate score for the one or more semantic orientations of each of the one or more features.

9. The storage medium of claim 1, wherein the opinionated text is derived from at least one of documentation, a periodical, a journal, information published in a website, information published in a blog, information published in a forum posting, or transcribed speech.

10. The storage medium of claim 1, comprising computer instructions for grouping synonymous features from the one or more tangible or intangible features.

11. The storage medium of claim 1, comprising computer instructions for identifying the one or more context-dependent opinions in the opinionated text from at least one of a dictionary of opinions or a linguistic pattern identifying a bias in portions of the opinionated text.

12. The storage medium of claim 11, wherein the bias corresponds to a favorable opinion, an unfavorable opinion, or a neutral opinion.

13. The storage medium of claim 1, wherein the object corresponds to a tangible and visible entity having the one or more tangible or intangible features identified in the opinionated text.

14. The storage medium of claim 1, wherein each of the one or more tangible or intangible features correspond to at least one of a component of the object, or a attribute of the object.

15. The storage medium of claim 14, wherein the attribute of the object corresponds to a least one of a qualitative aspect of the object, and a quantitative aspect of the object.

16. The storage medium of claim 1, comprising computer instructions for:
receiving one or more annotations to identify features of interest;
detecting one or more patterns in the one or more annotations received; and
identifying the one or more tangible or intangible features in the opinionated text according to the one or more detected patterns.

17. The storage medium of claim 1, comprising computer instructions for:
receiving one or more annotations to identify opinions of interest;
detecting one or more patterns in the one or more annotations received; and
identifying the one or more context-dependent opinions in the opinionated text according to the one or more detected patterns.

18. The storage medium of claim 1, wherein the storage medium operates in a web server providing portal services to customers mining opinion data.

19. A computer-readable storage medium, comprising computer instructions for:
identifying one or more tangible or intangible features of one or more articles of trade from commentaries directed to the one or more articles of trade;
identifying in the commentaries one or more context-dependent opinions associated with the one or more tangible or intangible features of the one or more articles of trade; and
determining a semantic orientation for each of the one or more context-dependent opinions of the one or more tangible or intangible features.

20. The storage medium of claim 19, comprising computer instructions for:
identifying from the one or more articles of trade first and second comparable articles of trade with comparable tangible or intangible features; and
presenting a comparison of the semantic orientation of each of the one or more context-dependent opinions of the first article of trade to the semantic orientation of each of the one or more context-dependent opinions of the second article of trade according to the comparable tangible or intangible features of said goods.

21. The storage medium of claim 19, wherein the commentaries express in whole or in part a bias associated with the one or more articles of trade, and wherein the commentaries comprise at least one of audio content, textual content, video content, or combinations thereof.

22. A computer-readable storage medium, comprising computer instructions for:
identifying one or more intangible features of one or more services from commentaries directed to the one or more services;
identifying in the commentaries one or more context-dependent opinions associated with the one or more intangible features of the one or more services; and
determining a semantic orientation for each of the one or more context-dependent opinions of the one or more intangible features.

23. The storage medium of claim 19, comprising computer instructions for:
identifying from the one or more services first and second comparable services with comparable intangible features; and
presenting a comparison of the semantic orientation of each of the one or more context-dependent opinions of the first service to the semantic orientation of each of the one or more context-dependent opinions of the second service according to the comparable intangible features of said services.

24. A system, comprising a controller to:
identify from commentaries of an object or service one or more context-dependent opinions associated with one or more features of the object or the service; and
synthesize a semantic orientation for each of one or more context-dependent opinions of the one or more features.

25. The system of claim 24, wherein each of the one or more features of the object or the service correspond to at least one of a tangible or intangible feature of the object, or an intangible feature of the service, wherein the commentaries express in whole or in part a bias associated with the object or service, and wherein the commentaries comprise at least one of audio content, textual content, video content, or combinations thereof.

26. The system of claim 24, wherein the semantic orientation corresponds to a favorable opinion, an unfavorable opinion, or a neutral opinion.
